(19) United States
(12) Patent Application Publication
(10) Pub. No.: US 2009/0045734 A1
(43) Pub. Date: Feb. 19, 2009

(54) NOVEL SILICON-TYPE COMPOUND AND AN ORGANIC ELECTROLUMINESCENT DISPLAY DEVICE USING THE SAME

(75) Inventors: Hyoung-don MOON, Osan-City (KR); Tae-Jin Park, Incheon (KR); Jong-Hyub Baek, Seoul (KR); Hoe-taek Yang, Hwaseong-City (KR); Hyun-cheol An, Hwaseong-city (KR)

Correspondence Address: LEXYOUME IP GROUP, LLC, 5180 PARKSTONE DRIVE, SUITE 175, CHANTILLY, VA, 20151, US

(73) Assignee: DONGJIN SEMICHEM Co., Ltd., Incheon (KR)

(21) Appl. No.: 12/190,124

(22) Filed: Aug. 12, 2008

(30) Foreign Application Priority Data
Aug. 17, 2007 (KR) 10-2007-0082969

(51) Int. Cl. H01J 1/63; C07F 7/10; C07F 7/08; B32B 3/00

(52) U.S. Cl. 313/504; 556/413; 556/489; 428/220

(57) ABSTRACT

The present invention relates to a silicon compound and an organic electroluminescent device using the same, and more particularly, to a silicon compound which has good blue light emission and enables an organic electroluminescent device to have a low voltage, high brightness and long lifetime, and an organic luminescent display device using the same.

### DETAILED DESCRIPTION OF THE INVENTION

1. Field of the Invention

The present invention relates to a silicon compound and an organic electroluminescent display device using the same, and more particularly, to a silicon-type compound which has good blue light emission and enables an organic electroluminescent display device to have a low voltage, high brightness and long lifetime, and an organic electroluminescent display device using the same.

2. Background of Invention

With the advancement in the information and telecommunication industry, display devices are being used increasingly, and light, thin and high-resolution display devices are being required. To meet the demand, LCDs and display devices using organic light emitting property have been developed.

To make a lighter, thinner display device, it is beneficial to use a lights thin plastic substrate instead of an existing display device employing a glass substrate. Among current display elements, an organic electroluminescent display device is most realistic to employ a plastic substrate, and researches are intensively being carried out.

An organic electroluminescent display device has such a configuration that an anode is formed on a substrate, and a hole transporting layer, a light emitting layer, an electron transporting layer and a cathode are sequentially formed on the anode. Here, the hole transporting layer, the light emitting layer and the electron transporting layer include organic thin layers having an organic compound.

With the foregoing configuration, a driving principle of an organic electroluminescent display device is as follows.

If a voltage is applied to the anode and cathode, a hole is moved from the anode to the light emitting layer through the hole transporting layer. Meanwhile, an electron is injected to the light emitting layer through the electron transporting layer while carriers are recombined in the light emitting layer to generate an exciton. The exciton is changed from an excited state to a ground state, and accordingly, fluorescent molecules in the light emitting layer emit light to thereby form an image. If the excited state is changed into a ground state through a singlet excited state, it is called fluorescence. If the excited state is changed into a ground state through a triplet excited state, it is called phosphorescence. As for the fluorescence, the probability of a single excited state is 25% (75% for a triplet state) and a light emitting efficiency is limited. Meanwhile, if phosphorescence is used, a triplet excited state of 75% and a singlet excited state of 25% may be used. Theoretically, up to 100% internal quantum efficiency is available.

An organic monomer which emits light by combination of a hole and an electron is largely divided into a host material and a guest material from a functional aspect. Generally, a host or guest material may emit light solely, but it is low in efficiency and brightness. Also, due to self-packing between the same molecules, excimer properties are shown instead of inherent properties of each molecule. Such a problem is addressed by dopping a guest material to a host material.

Organic materials for a blue light emitting layer present lower melting point and light emitting stability at an initial stage and a shorter lifetime than Alq3, a green light emitting body, does. Most blue light emitting layer materials are not pure blue but light blue, and inappropriate for full-color display. Thus, to enhance light emitting efficiency, the materials are dopped with perylene or distryl (DSA) amine. Representative blue light emitting layer materials include aromatic hydrocarbon, spiro type material, an organic metal compound having aluminum, heterocyclic compound having an imidazole group, a fused aromatic compound, etc., which are disclosed in U.S. Pat. No. 5,516,577, U.S. Pat. No. 5,366,811, U.S. Pat. No. 5,840,217, U.S. Pat. No. 5,150,006 and U.S. Pat. No. 5,645,948, respectively.

An organic electroluminescent display device which properly applies organic monomer materials to the respective layers has in general low lifetime, durability and reliability. The causes include physical, chemical, photochemical and electrochemical change in the organic materials, oxidation of cathode, exfoliation and melting, crystallization and pyrolysis of the organic materials.

The organic electroluminescent display device may have a predetermined light color by changing a structure of proper organic monomer materials. Various high efficiency organic, electroluminescent display devices in the host-guest system have been suggested, but they lack satisfactory brightness property, lifetime and durability from a commercial aspect.

Japanese Patent Application No. 2000-70609 discloses an organic electroluminescent display device including a specific silane compound, but it does not mention a phosphorescent element, and particularly, minimum excited energy sub rating or a width of an energy gap which are critical to highly efficient blue light.

### CONTENTS OF THE INVENTION

### Objectives to Solve

Accordingly, it is an aspect of the present invention to provide a compound which has good blue light emission and enables an organic electroluminescent display device to have a low voltage, high brightness and long lifetime.

Also, it is another aspect of the present invention to provide an organic thin layer of an organic electroluminescent display device, an organic electroluminescent display device and a display device including the same which emit light in high efficiency and provide low voltage, high brightness and long lifetime.

### Means for Achieving the Objectives

The foregoing and/or other aspects of the present invention are also achieved by providing a silicon compound which is represented by a following chemical formula 1.

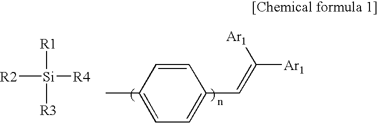

wherein, one or two of R1 to R4 is independently, and the rest comprises a substituted or unsubstituted aryl group having six to 50 carbon atoms or a substituted or unsubstituted alkyl group having one to 50 carbon atoms,

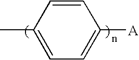

wherein, Ar₁ is

A refers to an amine derivative having an alkyl group and an aryl group including one to 20 hydrogen atoms or carbon atoms, and N is 1 or 2.

The foregoing and/or other aspects of the present invention are also achieved by providing an organic thin layer of an organic electroluminescent device which is formed by the silicon compound.

The foregoing and/or other aspects of the present invention are also achieved by providing an organic electroluminescent device which comprises at least one organic thin layer between an anode and a cathode, the organic luminescent device comprising at least one organic thin layer.

The foregoing and/or other aspects of the present invention are also achieved by providing a display device which comprises the organic electroluminescent device.

Effect

A silicon compound which is represented by a chemical formula 1 according to the present invention may have good blue light emission and enable an organic electroluminescent display device to have a low voltage, high brightness and long lifetime.

### DETAILED DESCRIPTION OF EXEMPLARY EMBODIMENT

A silicon compound which is represented by a chemical formula 1 according to the present invention may have good blue light emission and enable an organic electroluminescent display device to have a low voltage, high brightness and long lifetime.

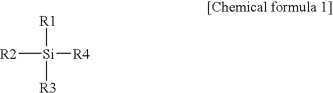

In the chemical formula 1, one or two of R1 to R4 is

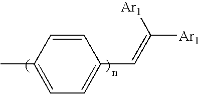

independently, and the rest of R1 to R4 include a substituted or unsubstituted aryl group having six to 50 carbon atoms or a substituted or unsubstituted alkyl group having one to 50 carbon atoms. Arl in the formula is

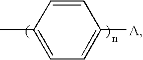

A refers to an amine derivative having an alkyl group and aryl group including one to 20 hydrogen atoms or carbon atoms and n is 1 or 2.

An exemplary embodiment of the compound which is represented by the chemical formula 1 according to the present invention is a compound that is represented by following chemical formulas 1-1 to 1-16.

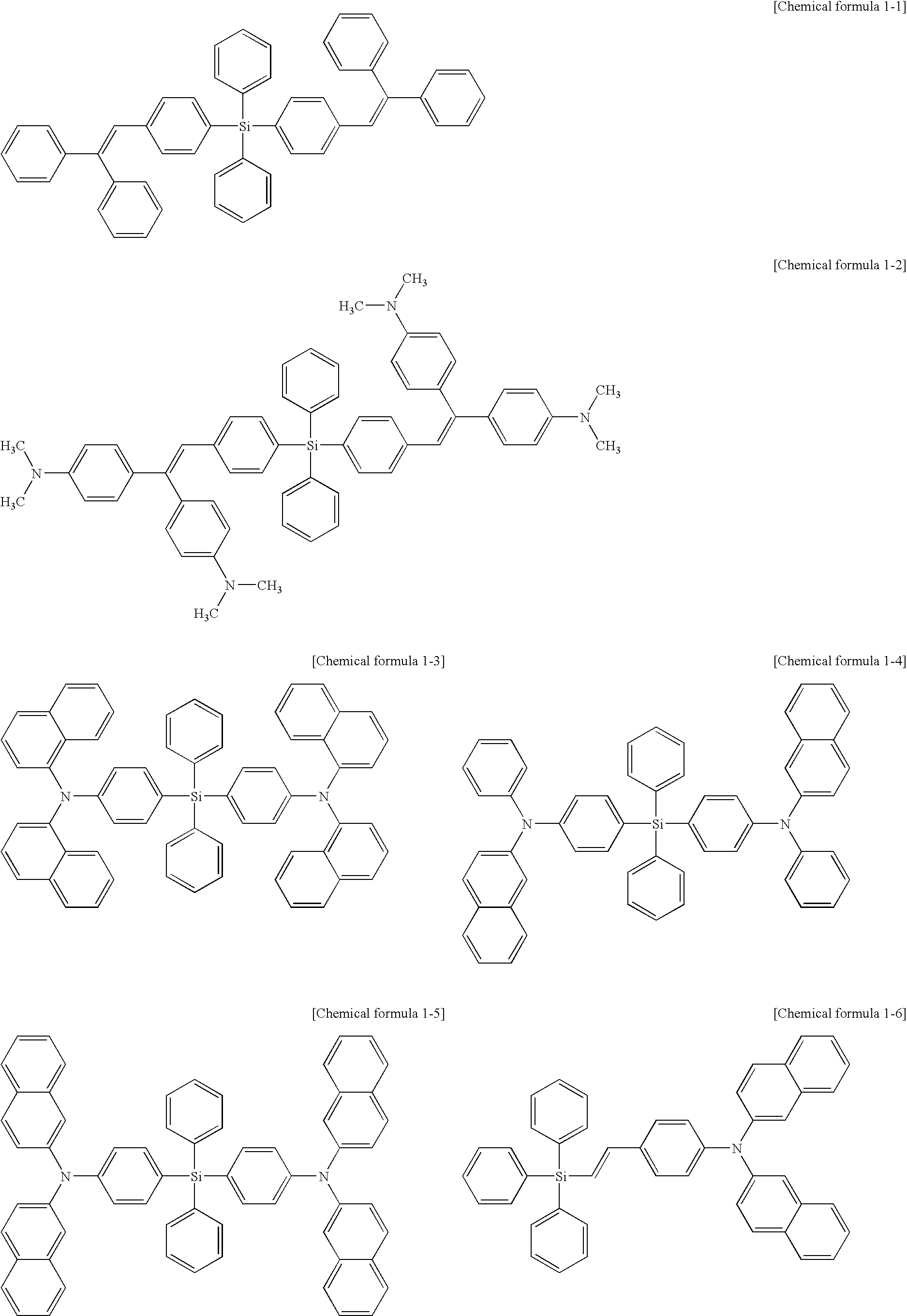

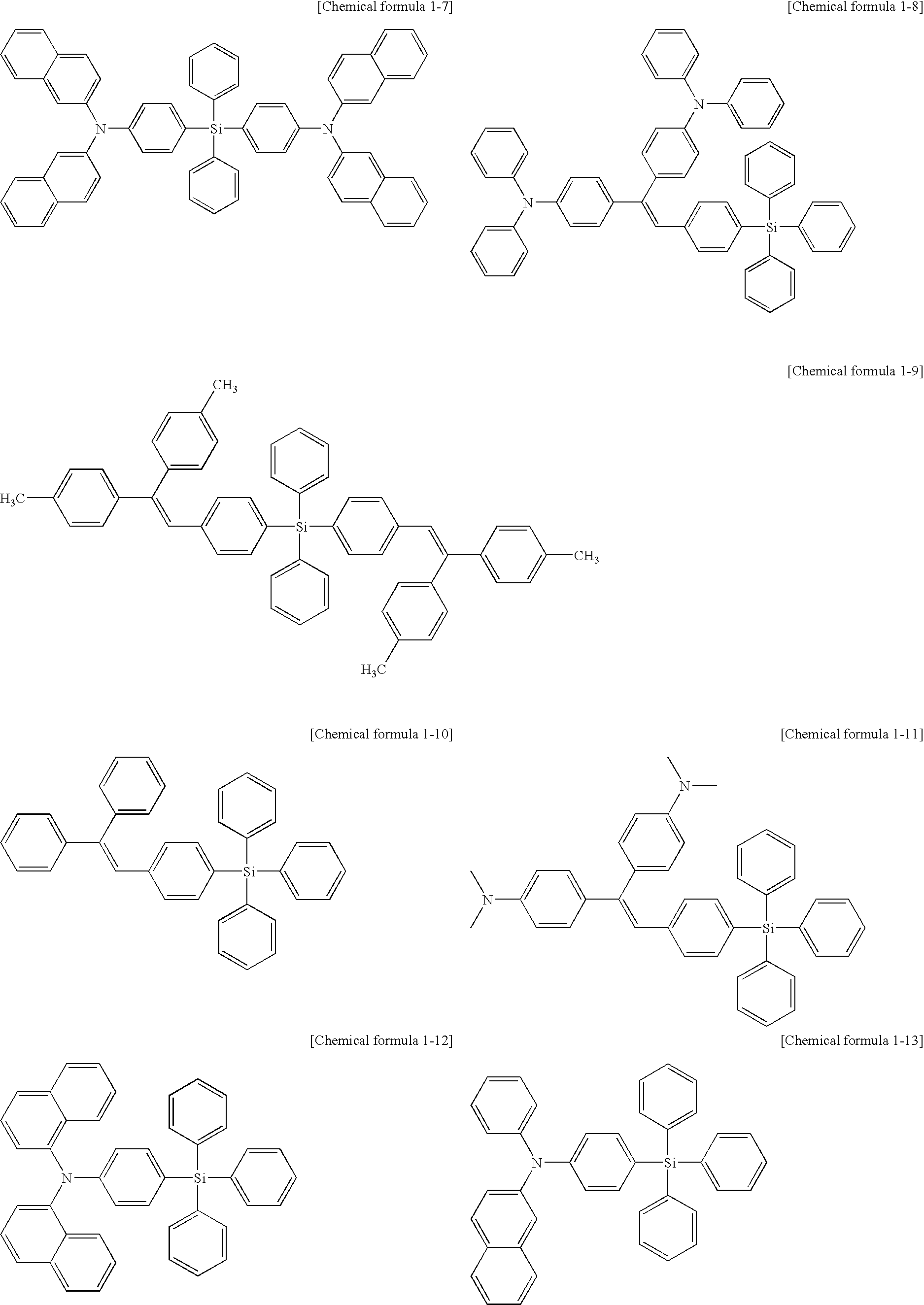

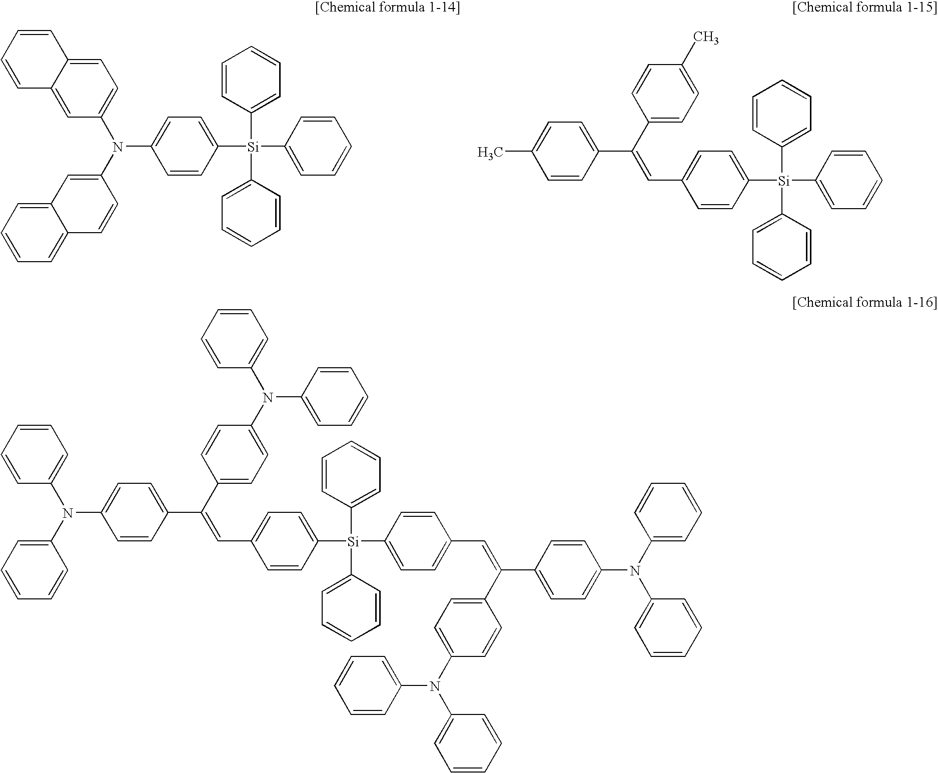

A compound which includes a silicon group according to the present invention may be made by a following reaction formula 1, which is an example of making the compound having the silicon compound according to the present invention, but the making method of the compound is not limited thereto.

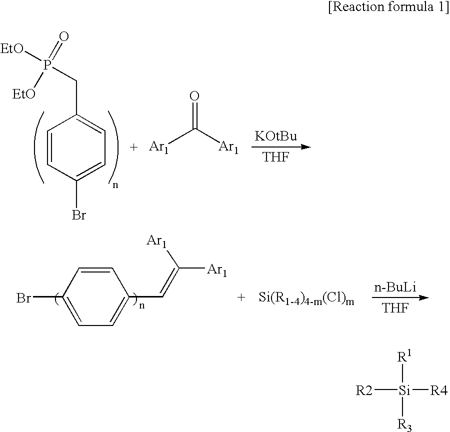

In the reaction formula 1, R1 to R4, Ar₁ and n are the same as those mentioned above while m refers to a positive number from zero to four.

The present invention also provides an organic thin layer of an organic electroluminescent device formed by the chemical formula 1 according to the present invention and an organic electroluminescent device including at least one organic thin layer. The manufacturing method of the organic electroluminescent device is as follows.

In general, an organic electroluminescent device may include at least one organic thin layer such as a hole injecting layer (HIL), a hole transporting layer (HTL), a light emitting layer (EML), an electron transporting layer (ETL) and an electron injecting layer between anode and cathode.

First, an anode electrode material which has a high work function is deposited on a substrate to form an anode. The substrate may include a substrate used for a typical organic electroluminescent display device, and more particularly, a glass substrate or a transparent plastic substrate which has good mechanical strength, thermal stability, transparency, surface planarization and water proofness and is easy to handle. The anode electrode material may include indium tin oxide (ITO), indium zinc oxide (IZO), SnO₂ or ZnO which is transparent and highly conductive. The anode electrode material may be deposited by a typical anode forming method, and more specifically, by deposition or sputtering.

A hole injecting layer may be formed on the anode electrode by a vacuum deposition, spin coating, cast or LB (Langmuir-Blodgett). Preferably, the hole injecting layer is formed by a vacuum deposition since it may be uniform and hardly have a pin hole. If the hole injecting layer is formed by the vacuum deposition, the deposition condition differs by a compound used as a material for the hole injecting layer and a configuration and a thermal property of the desired hole injecting layer. Generally, however, the deposition condition may be determined within a deposition temperature of 50 to 500° C., vacuum degree of 10⁻⁸ to 10⁻³ Torr, a deposition speed of 0.01 to 100 Å/sec and a layer thickness of 10 Å to 5 μm.

The hole injecting layer material may include a phthalocyanine compound such as copper phthalocyanine disclosed in U.S. Pat. No. 4,356,429 or TCTA, m-MTDATA, m-MTDAPB (Advanced Material, 6, p 677 (1994)) as starburst amine derivatives, but not limited thereto.

A hole transporting layer may be formed on the hole injecting layer by a vacuum deposition, spin coating, cast or LB. Preferably, the hole transporting layer is formed by a vacuum deposition since it may be uniform and hardly have a pin hole. If the hole transporting layer is formed by the vacuum deposition, the deposition condition differs by a compound used. Generally, however, the deposition condition may be almost equivalent to those of the hole injecting layer.

The hole transporting layer material may be selected from typically known materials used for the hole transporting layer, but not limited thereto. More specifically, the hole transporting layer may include a carbazole derivative such as N-phenyl carbazole and polyvinylcarbazole, or typical amine derivatives having an aromatic ring such as N,N′-bis(3-methylphenyl)-N,N′-diphenyl-[1,1-biphenyl]-4,4′-diamine (TPD), N,N′-di(naphthalene-1-yl)-N,N′-diphenyl benzidine(a-NPD).

A light emitting layer may be formed on the hole transporting layer by a vacuum deposition, spin coating, cast or LB. Preferably, the light emitting layer is formed by a vacuum deposition since it may be uniform and hardly have a pin hole. If the light emitting layer is formed by the vacuum deposition, the deposition condition differs by a compound used. Generally, however, the deposition condition may be almost equivalent to those of the hole injecting layer. The light emitting layer material may include a compound represented by the chemical formula 1 according to the present invention only or as a host.

If the compound which is represented by the chemical formula 1 is used as a light emitting host, a phosphorescent or fluorescent dopant may be used together to form the light emitting layer. The fluorescent dopant may include IDE102 or IDE105 manufactured by Idemitsu. The phosphorescent dopant may include Ir(ppy)3(fac tris(2-phenylpyridine)iridium) as a green phosphorescent dopant and F2Irpic(iridium(III)bis[4,6-di-fluorophenly)-pyridinato-N,C2′]picolinate) as a blue phosphorescent dopant, and RD61 as a red phosphorescent dopant manufactured by UDC which may be commonly vacuum deposited (doped). A doping density of the dopants may be 0.01 to 15 wt % versus the host of 100 wt %, but not limited thereto. If the content of the dopant is below 0.01 wt %, it is not sufficient to present colors. If the content of the dopant exceeds 15 wt %, efficiency sharply decreases due to concentration quenching.

Preferably, if used together with a phosphorescent dopant to the light emitting layer, a hole blocking material may be deposited additionally by a vacuum deposition or spin coating to thereby prevent a triplet exiton or hole from being spread to the hole transporting layer. The hole blocking material may be determined among those known in the art, but not limited thereto. For example, the hole blocking material may include an oxadiazole derivative, a triazole derivative, phenanthroline derivative or a hole blocking material disclosed in Japanese Patent First Publication 1999-329734(A1), and representatively, Balq, a phenanthrolines compound (e.g., BCP made by UDC).

An electron transporting layer is formed on the light emitting layer by a vacuum deposition, spin coating, cast, etc., and preferably, by a vacuum deposition.

The electron transporting layer material may include e.g., a quinoline derivative, and more particularly, tris(8-quinolinorate)aluminum (Alq3) to stably transport electrons from a cathode, but not limited thereto. An electron injecting layer which is used to inject electrons from a cathode may be formed on the electron transporting layer. The electron injecting layer material may include LiF, NaCl, CsF, Li₂O, BaO, etc.

The deposition condition of the electron transporting layer may differ by a used compound, but preferably be almost equivalent to those of the hole injecting layer.

An electron injecting layer may be formed on the electron transporting layer by a vacuum deposition, spin coating, cast, etc., and preferably, by a vacuum deposition.

A cathode is finally formed on the electron injecting layer by a vacuum deposition or sputtering with a cathode forming metal. The cathode forming metal may include metal, alloy, conductive compound and a mixture thereof which has a low work function. More specifically, the metal may include lithium (Li), magnesium (Mg), aluminum (Al), aluminum-lithium (Al—Li), calcium (Ca), magnesium-indium (Mg—In), magnesium-silver (Mg—Ag), etc. A transmissive cathode with ITO or IZO may be used to make a frontal electroluminescent display device.

The organic electroluminescent device according to the present invention may have various configurations as well as a configuration of anode, hole injecting layer, hole transporting layer, light emitting layer, electron transporting layer, electron injecting layer and cathode. A single or double intermediate layers may be formed as necessary. FIGS. 1 to 3 illustrate a PL spectrum measured with a compound represented by chemical formulas 1-1, 1-2 and 1-8 according to the present invention, showing that the compound can be highly applicable to the organic electroluminescent display device.

The thickness of the organic thin layer formed by the present invention may be adjusted as required. Preferably, the thickness of the organic thin layer is 10 to 1,000 μm, and more preferably, 20 to 150 μm.

An organic thin layer according to the present invention is formed by depositing a silicon compound represented by the chemical formula 1. The organic thin layer has good adhesion to a substrate and good stability, and uniform surface as the thickness is adjusted by molecule.

Hereinafter, exemplary embodiments of the present invention are provided to help understand the present invention. However, the present invention is not limited to following exemplary embodiments.

### Exemplary Embodiment

### Exemplary Embodiment 1: Fabrication of a Compound Represented by Chemical Formula 1-1

After 1-bromo-4-(2,2-diphenyl)-benzene (5.4 g, 16 mmol) was melted by TFT of 80 ml, 2M n-BuLi (9 ml, 19.2 mmol) was gradually added to the liquid at −78° C. to be stirred for one hour at low temperatures. Dichlorodiphenylsilane (1.94 ml, 9.6 mmol) was gradually added to the mixture at −78° C., stirred for one hour at low temperatures and then additionally stirred for 30 minutes at 0° C. After extracting an organic layer from the mixture with dichloromethane and distilled water, a solvent was removed by an evaporator and the mixture was recrystallized by using n-hexane. A sediment was filtered, dried and purified to obtain a final compound [Chemical formula 1-1] (yield 54%).

¹H NMR(CDCl₃ ):[ppm]=6.96 (s, 2H), 7.00 (d, J=8 Hz, 4H), 7.20 (m, 2H), 7.28 (d, J=8 Hz, 8H), 7.31 (m, 20H), 7.47 (dd, J=8 Hz, 4H)

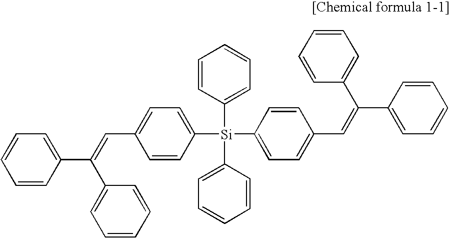

### Exemplary Embodiment 2: Fabrication of a Compound Represented by Chemical Formula 1-2

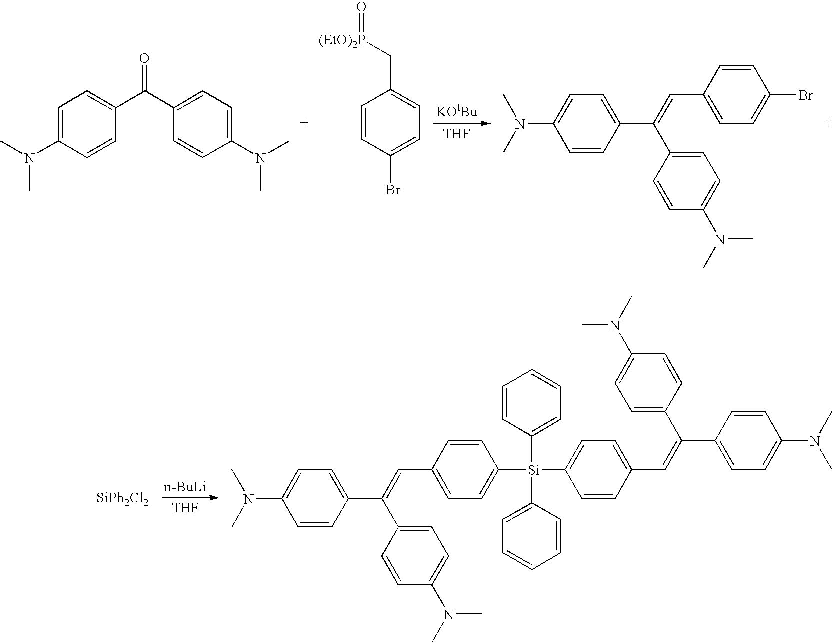

Bis-(4-dimethylaminophenyl)-methanone(5.77 g, 21.52 mmol), (4-bromobenzyl)-phosphonic acid-diphenylester (12.4 g, 17.94 mmol) and potassium-tert-butoxide (2.41 g, 21.52 mmol) were melted by THF of 50 ml to be stirred for eight hours under nitrogen atmosphere. After reaction was finished, an organic layer was extracted from the compound with methylenechloride and distilled water, dried and then purified with column chromatography initiator (methylenechloride:hexane=2:1) to thereby obtain 4,4′-(2-(4-bromophenyl)ethene-1,1-diyl)bis(N,N-dimethylbenzeneamine (yield 72%).

¹H NMR(CDCl₃):[ppm]=2.97(s, 12H), 6.65(s, 1H), 6.66 (d, J=8.8 Hz, 4H), 6.92(d, J=8.8 Hz, 2H), 7.04(d, J=8.8 Hz, 2H), 7.22(J=8.8 Hz, 4H).

After 4,4′-(2-(4-bromophenyl)ethene-1,1-diyl)bis(N,N-dimethylbenzeneamine (3.11 g, 7.38 mmol) was melted by THF of 30 ml, n-BuLi (5.16 ml, 10.33 mmol) was gradually added at −78° C. to stir the compound for one hour under nitrogen atmosphere. After stirring, diphenyldichlorosilane (3.04 ml, 14.76 mmol) was gradually added at −78° C., stirred for one hour and then additionally stirred for 30 minutes at 0° C. Then, an organic layer was extracted from the mixture with methylenechloride and distilled water, dried and purified with column chromatography initiator (methylenechloride:hexane=2:1) to obtain a final compound [Chemical formula 1-2] (yield 42%).

¹H NMR(CDCl₃):[ppm]=2.93(s, 24H), 6.66(d, J=8.8 Hz, 8H), 6.74(s, 2H), 7.06(m, 4H), 7.23(d, J=8.8 Hz, 4H), 7.37(d, J=8.8 Hz, 8H), 7.42(m, 6H), 7.60(d, J=4H)

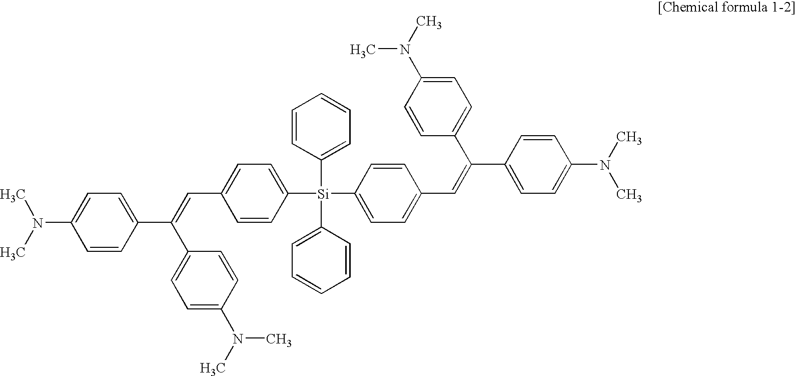

### Exemplary Embodiment 3: Fabrication of Compound Represented by Chemical Formula 1-5

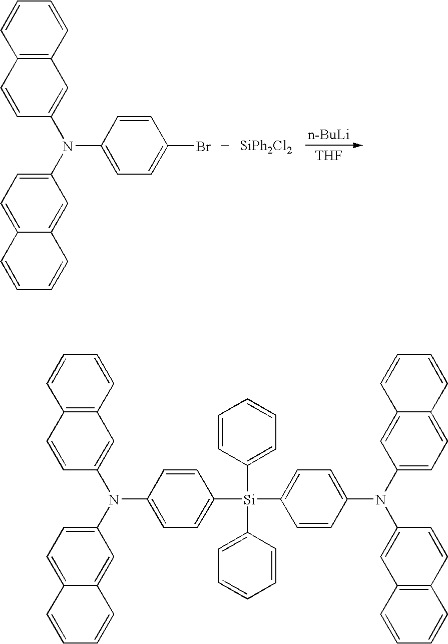

After (4-bromophenyl)-dinaphthalene-2-yl-amine (2.63 g, 6.2 mmol) was melted with THF of 30 ml, n-BuLi (3.22 ml, 6.44 mmol) was gradually added at −78° C. to stir the mixture for one hour under nitrogen atmosphere. After stirring, diphenyldichlorosilane (0.63 ml, 3.1 mmol) was gradually added to the mixture at −78° C., stirred for one more hour and then additionally stirred for 30 minutes at 0° C. An organic layer was extracted from the mixture with methylenechloride and distilled water, and then purified with column chromatography initiator (methylenechloride:hexane=1:3) to obtain a final compound [Chemical formula 1-5] (yield 43%).

¹H NMR(CDCl₃):[ppm]=7.03(m=8H), 7.19(d, 3J=11.2 Hz, 4H), 7.33(m=4H), 7.38(m, 8H), 7.41(m, 8H), 7.65(d, J=4H), 7.75(m, 8H)

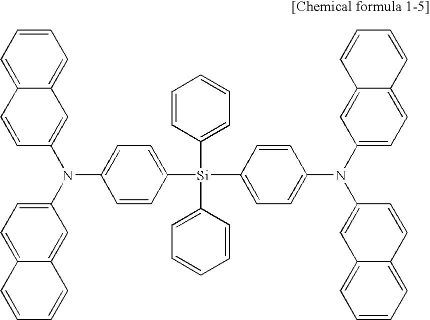

### Exemplary Embodiment 4: Fabrication of Compound Represented by Chemical Formula 1-8

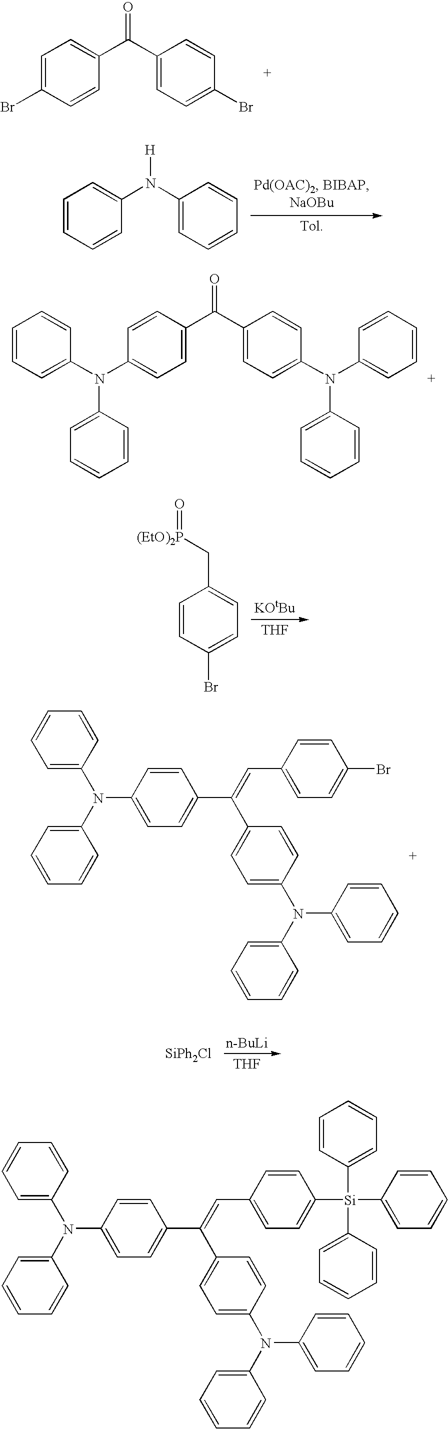

4,4-dibromobenzenephenone (3 g, 8.8 mmol), diphenylamine (2.97 g, 17.6 mmol), [rac-2,2-bis(diphenylphoshino)-(1,1-binaphtyl] (0.217 g, 0.35 mmol), sodium-tert-butoxide (2.03 g, 21.12 mmol) and palladium(II)acetate (0.12 g, 0.528 mmol) were melted by toluene of 50 ml to be convected for 12 hours in the nitrogen state. After reaction ended, an organic layer was extracted from the mixture with methylenechloride and distilled water, dried and purified with column chromatography initiator (methylenechloride) to obtain 4,4′-(2-(4-bromophenyl)ethene-1,1-diyl)bis(N,N-diphenylbenzeneamine) (yield 68%).

¹H NMR(CDCl₃):[ppm]=6.52(d, J=8.8 Hz, 8H), 6.58(m, 4H), 6.62(m, 4H), 7.01(m, 8H), 7.52(d, J=4H)

After 4,4′-(2-(4-bromophenyl)ethene-1,1-diyl)bis(N,N-diphenylbenzeneamine) (0.54 g, 0.806 mmol) was melted with THF of 30 ml, n-BuLi (0.48 ml, 0.97 mmol) was gradually added to the mixture at −78° C. to be stirred for one hour under nitrogen atmosphere. Chlorotriphenylsilane (0.28 g, 0.97 mmol) was gradually added to the mixture at −78° C., and then the mixture was stirred for one hour and then additionally stirred for 30 minutes. An organic layer was extracted from the mixture with methylenechloride and water, dried and purified with column chromatography initiator (methylenechloride:hexane=1:2) to obtain a final compound [chemical formula 1-8] (yield 45%).

¹H NMR(CDCl₃):[ppm]=6.46(m, 12H), 6.62(m, 4H), 6.94(s, 1H), 7.05(m, 8H), 7.15(d, J=4H), 7.32(m, 9H), 7.54(m, 10H).

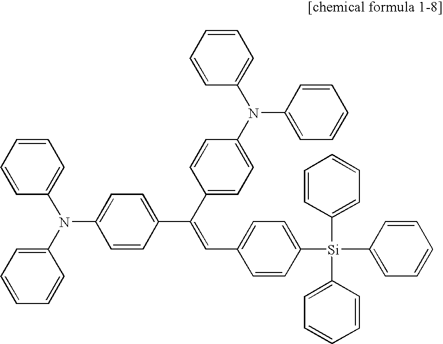

### Exemplary Embodiment 5: Fabrication of Compound Represented by Chemical Formula 1-9

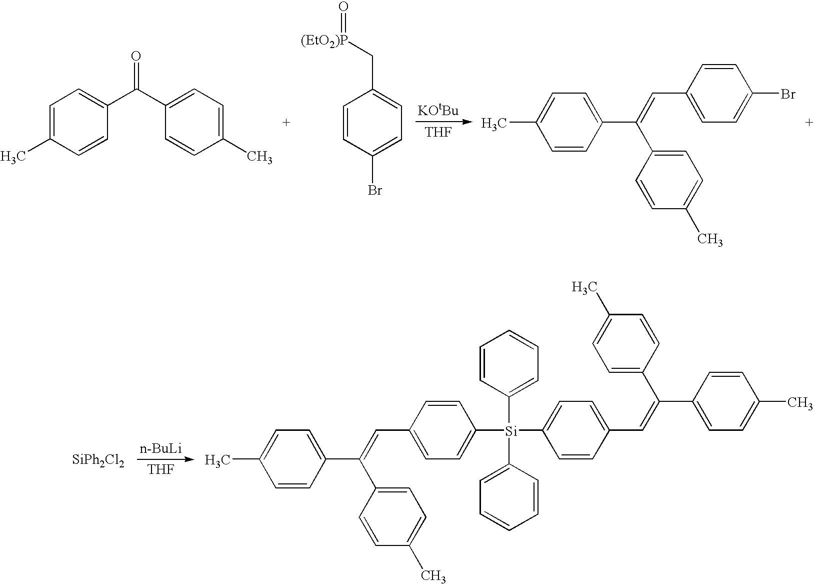

Di-p-tolyl-methanone(4.52 g, 21.52 mmol), (4-bromobenzyl)-phosphonic acid diethylester (12.4 g, 17.94 mmol) and potassium-tert-butoxide (2.41 g, 21.52 mmol) were melted with THF of 50 ml to be stirred for 8 hours under nitrogen atmosphere. After reaction ended, an organic layer was extracted from the mixture with methylenechloride and distilled water, dried and purified with column chromatography initiator (methylenechloride:hexane=2:1) to obtain 4,4′-(2-(4-bromophenyl)ethene-1,1-diyl)bismethylbenzene (yield 74%).

¹H NMR(CDCl₃):[ppm]=2.32(s, 6H), 6.68(s, 1H), 7.10 (d, J=8.4 Hz, 4H), 7.31(d, J=8.4 Hz, 4H), 7.38(d, J=8.8 Hz, 2H), 7.42(J=8.8 Hz, 2H).

After 4,4′-(2-(4-bromophenyl)ethene-1,1-diyl)bismethylbenzene (4.82 g, 13.27 mmol) was melted by THF of 30 ml, n-BuLi (7.96 ml, 15.93 mmol) was gradually added to the mixture at −78° C. to be stirred for one hour under nitrogen atmosphere. After stirring, diphenyldichlorosilane (1.27 ml, 6.03 mmol) was gradually added to the mixture at −78° C., stirred for one hour and then additionally stirred for 30 minutes at 0° C. An organic layer was extracted from the mixture with methylenechloride and distilled water, dried and purified with column chromatography initiator (methylenechloride:hexane=1:3) to obtain a final compound [chemical formula 1-9] (yield 48%).

¹H NMR(CDCl₃):[ppm]=2.31(s=12H), 6.72(s, 2H), 7.06(J=8.4 Hz, 8H), 7.28(J=8.4 Hz, 8H), 7.38(m, 6H), 7.54(m=12H).

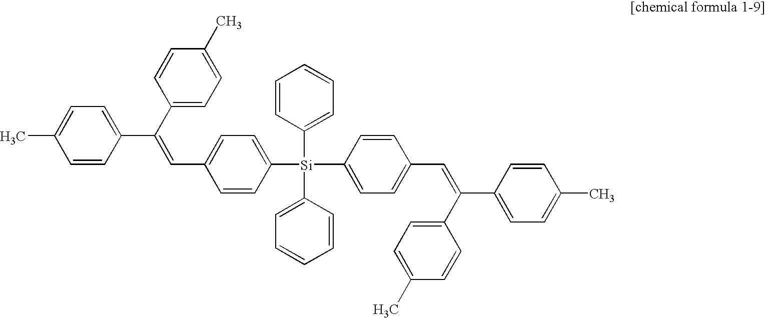

### Exemplary Embodiment 6: Electrochemical Deposition

To measure electrochemical properties, highest occupied molecular orbitals (HOMO) and lowest unoccupied molecular orbitals (LUMO) of the compounds according to the exemplary embodiment 1 and 2, CV test was conducted by using Pt working electrode, Pt counter electrode and Ag/Ag+ (0.1M) electrode as base electrode. CV test was conducted by melting 0.1M TBAPF₆ as an electrolyte with DMF solvent, injecting nitrogen gas and varying measuring speeds. The measured values were verified based on ferrocene. Electrochemical deposition using CV was performed at a speed of 100 mV/s.

FIGS. 4 and 5 illustrate CV of a compound according to the exemplary embodiment 1. As shown therein, it was found that all the compounds were electrochemically deposited.

### BRIEF DESCRIPTION OF THE DRAWINGS

FIG. 1 illustrates a PL spectrum which uses a compound represented by a chemical formula 1-1 according to the present invention;

FIG. 2 illustrates a PL spectrum which uses a compound represented by a chemical formula 1-2 according to the present invention;

FIG. 3 illustrates a PL spectrum which uses a compound represented by a chemical formula 1-8 according to the present invention;

FIG. 4 illustrates a cyclic voltamonogram which shows an electrochemical deposition with a silicon compound represented by a chemical formula 1-1 according to an exemplary embodiment 1 of the present invention; and

FIG. 5 illustrates a cyclic voltamonogram which shows an electrochemical deposition with a silicon compound represented by a chemical formula 1-2 according to an exemplary embodiment 2 of the present invention.

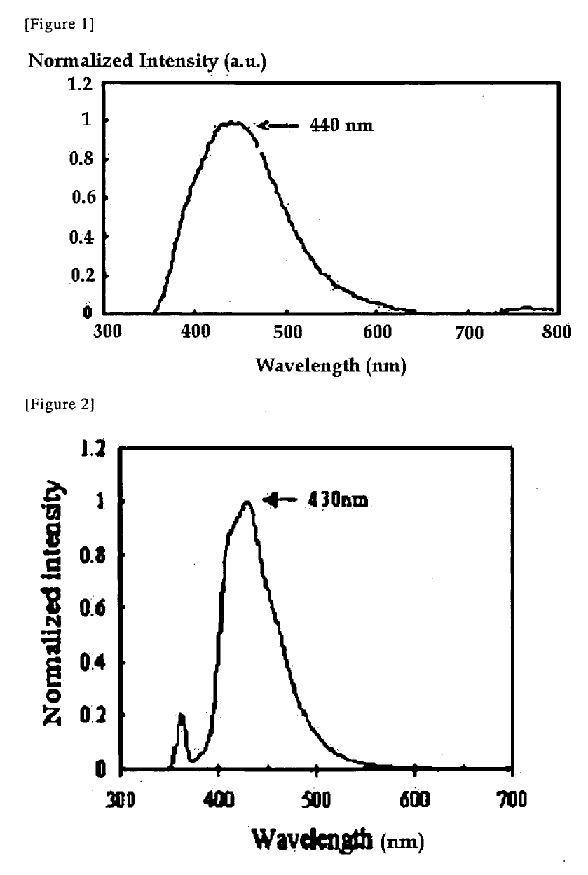

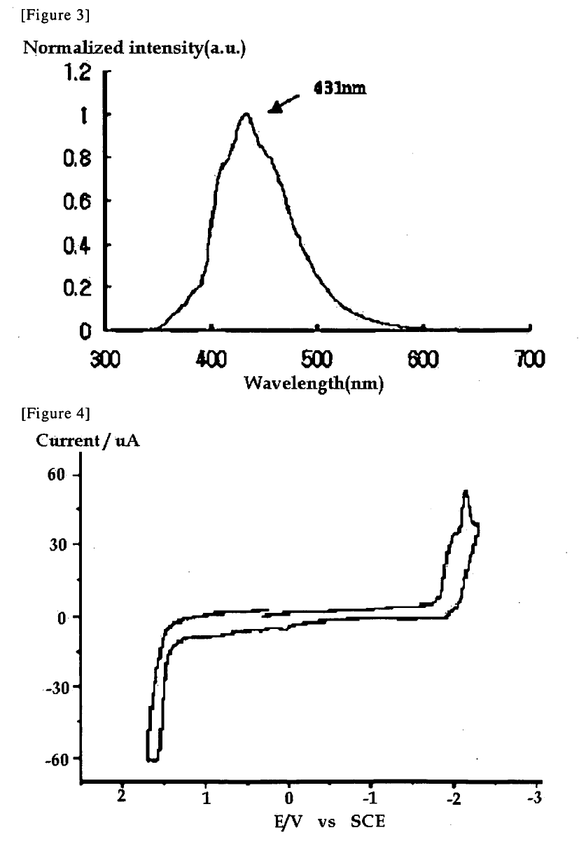

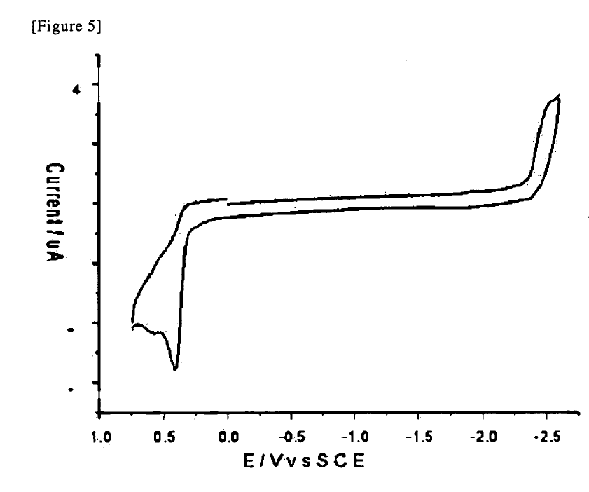

What is claimed is:

1. A compound which is represented by a following chemical formula 1: 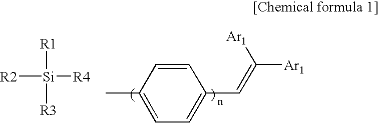
wherein, one or two of R1 to R4 is independently, and a rest comprises a substituted or unsubstituted aryl group having six to 50 carbon atoms or a substituted or unsubstituted alkyl group having one to 50 carbon atoms, 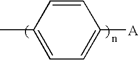
wherein, Ar₁ is
A refers to an amine derivative having an alkyl group and an aryl group including one to 20 hydrogen atoms or carbon atoms, and N is 1 or 2.

2. The compound according to claim 1, wherein the compound of the chemical formula 1 is represented by following chemical formulas 1-1 to 1-16.

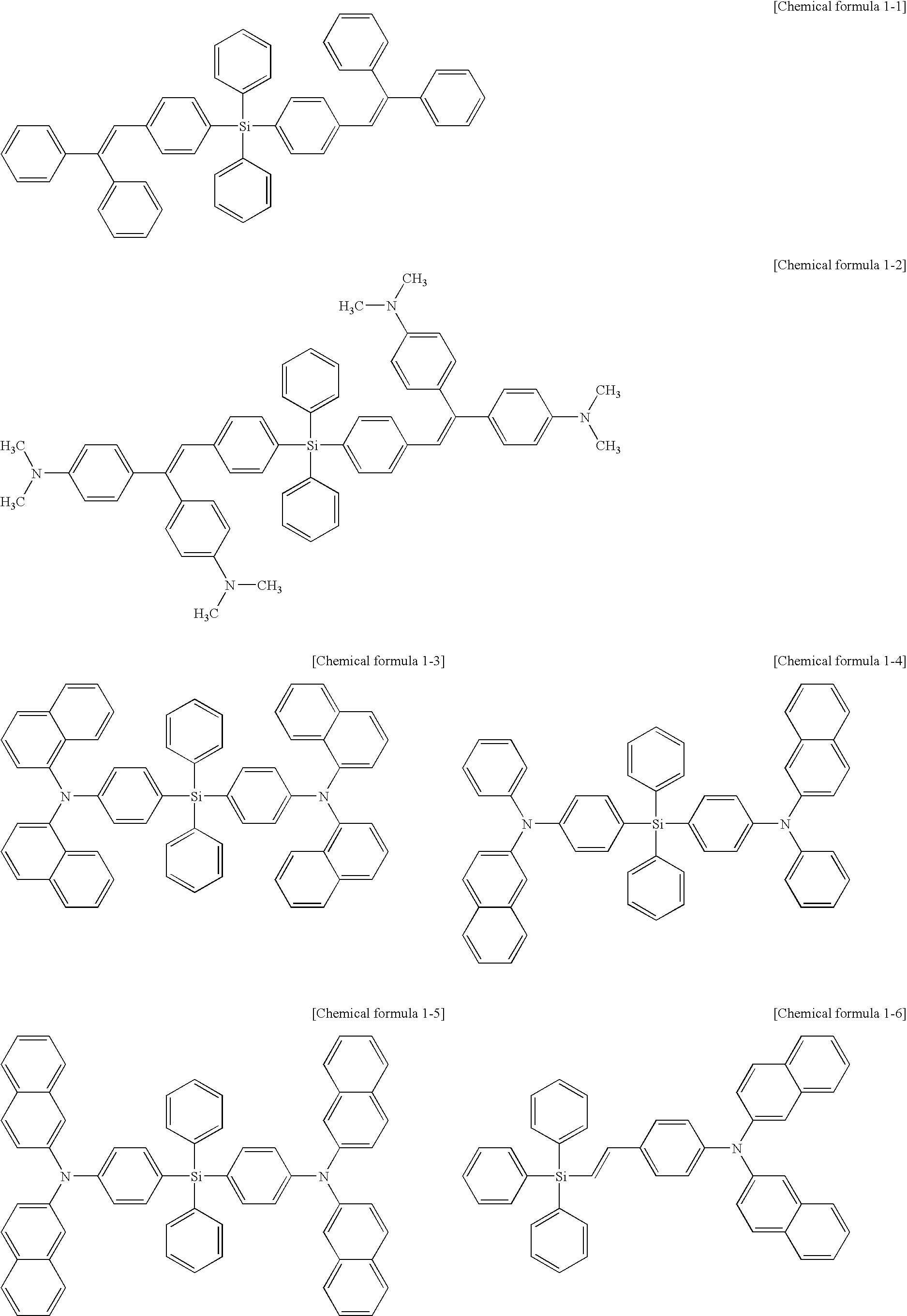

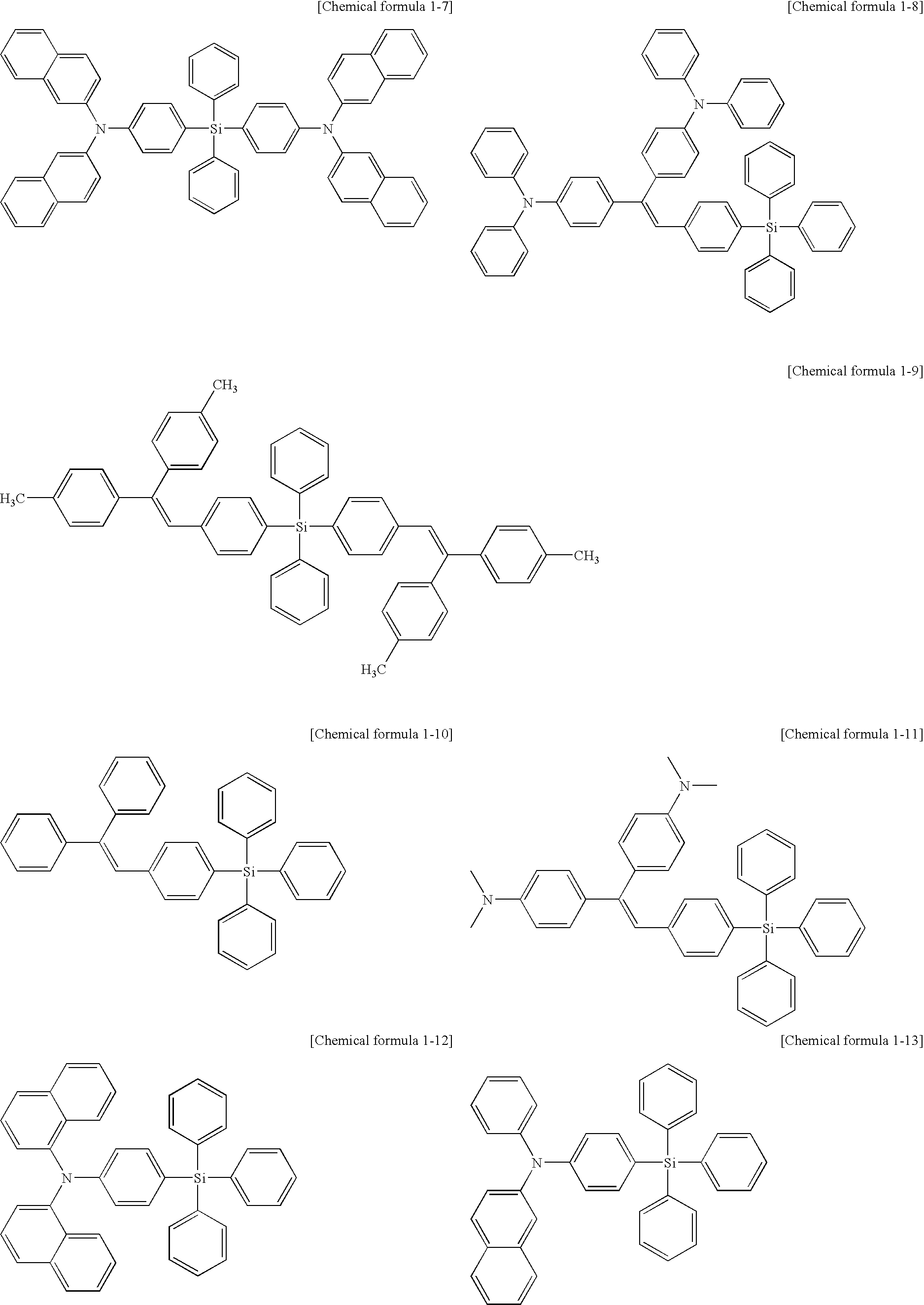

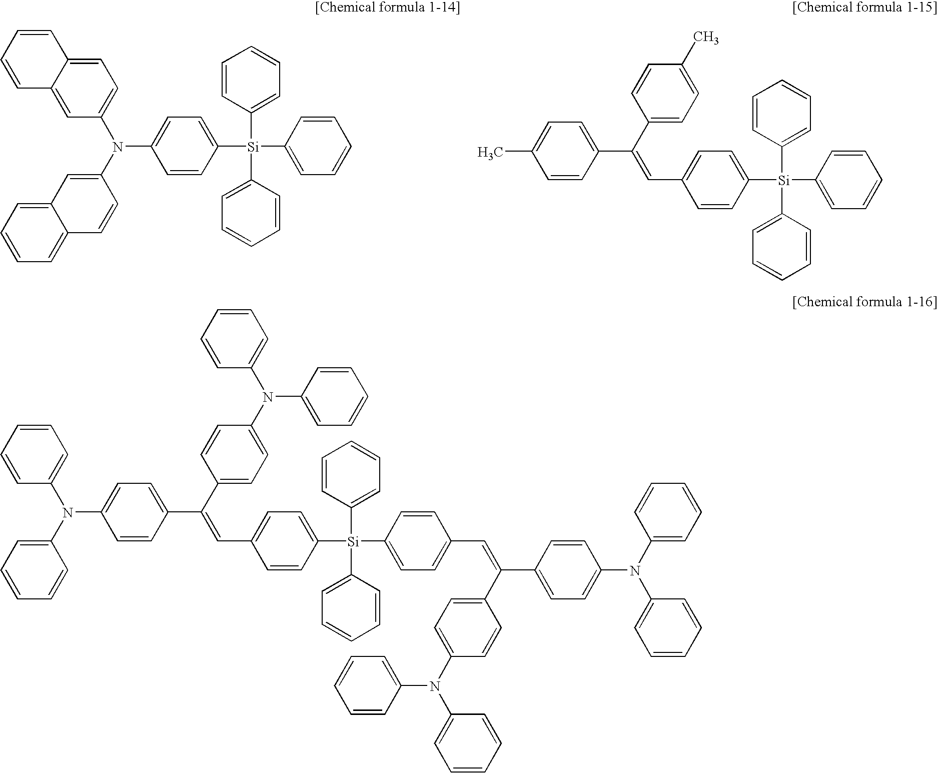

3. An organic thin layer of an organic electroluminescent device which is formed by a compound according to claim 1.

4. The organic thin layer of an organic electroluminescent device according to claim 3, which comprises the compound according to claim 1 as a blue light emitting material.

5. The organic thin layer of an organic electroluminescent device according to claim 3, which comprises a light emitting layer.

6. The organic thin layer of an organic electroluminescent device according to claim 3, wherein a doping density of a dopant is 0.01 to 15 wt % versus a host of 100 wt %.

7. The organic thin layer of an organic electroluminescent device according to claim 3, wherein a thickness of the organic thin layer ranges from 10 to 1,000 nm.

8. An organic electroluminescent device which comprises at least one organic thin layer between an anode and a cathode, the organic luminescent display device comprising at least one organic thin layer according to claim 3.

9. A display device which comprises an organic electroluminescent device according to claim 8.
